(19) United States
(12) Patent Application Publication
(10) Pub. No.: US 2026/0204188 A1
(43) Pub. Date: Jul. 16, 2026

(54) Snow Globe Ornament

(71) Applicant: Tian

(72) Inventor: Julian Jiang, Dongguan City (CN)

(21) Appl. No.: 19/017,154

(22) Filed: Jan. 10, 2025

(51) Int. Cl. G09F 19/12

(52) U.S. Cl. CPC G09F 19/12

(57) ABSTRACT

The present invention relates to the technical field of decorative articles, and in particular to a snow globe ornament, including a snow globe body and a base arranged up and down, and the base comprises a driving mechanism and a rotating structure; wherein the driving mechanism includes a sealing cover, a driving motor and a transmission bracket, the sealing cover and the snow globe body are sealed and connected to form a liquid containing cavity for containing liquid; the rotating structure includes a rotating disk, and the rotating disk is provided with a mounting position for installing the ornament; when liquid is injected into the liquid containing cavity and the driving motor is started, the driving motor drives the transmission bracket to rotate through the output shaft.

### FIELD OF THE INVENTION

The present invention relates to the technical field of decorative articles, and in particular to a snow globe ornament.

### BACKGROUND OF THE INVENTION

Snow globe ornaments are deeply loved by people because of their crystal clear appearance and elegant decorative atmosphere, which are often placed in homes, living rooms, offices and other places for appreciating. They not only bring visual enjoyment, but also provide a quiet and elegant atmosphere. The snow globe body in the snow globe ornament is a transparent sphere made of materials such as polycarbonate, glass, resin, or natural crystal columns, and the sphere is a hollow structure filled with water and small particles. When shanking the snow globe ornament, these small particles will flow with the shaking of the water, and giving the snow globe ornament a certain dynamic visual effect as a whole. However, the internal movable elements of traditional snow globe ornaments are mainly small particles, the dynamic visual effects are relatively simple, the degree of attraction to consumers will gradually decrease after a long period of viewing, making it difficult to satisfy people's growing demand for novelty and diversity in visual effects.

### SUMMARY OF THE DISCLOSURE

In view of this, the present invention proposes a snow globe ornament, aiming to solve the problem of relatively single dynamic visual effects of traditional snow globe ornaments.

The invention proposes a snow globe ornament, which includes a snow globe body and a base arranged up and down, and the base includes a driving mechanism and a rotating structure; wherein the driving mechanism includes a sealing cover, a driving motor and a transmission bracket. The sealing cover and the snow globe body are sealed and connected to form a liquid containing cavity for containing liquid, the transmission bracket is provided between the sealing cover and the driving motor and is disposed below the liquid containing cavity, the transmission bracket is connected to the output shaft of the driving motor and the transmission bracket can rotate around the output shaft of it, and the transmission bracket is provided with a first magnetic block.

The rotating structure includes a rotating disk, which is provided inside the liquid containing cavity. The rotating disk is provided with a second magnetic block and a mounting position for the ornament, the second magnetic block and the first magnetic block are relatively disposed at the upper and lower sides of the sealing cover and attract each other.

When liquid is injected into the liquid containing cavity and the driving motor is started, the driving motor drives the transmission bracket to rotate through the output shaft, then the rotated transmission bracket drives the rotating disk to rotate through magnetic attraction, so as to drive the ornament installed at the installation position to rotate.

In a possible embodiment, the snow globe ornament further includes an ornament and dispersed pieces, the ornament is fixedly connected to the aforementioned mounting position, and the dispersed pieces are provided in the liquid containing cavity.

In a possible embodiment, the snow globe ornament further includes an impeller provided inside the liquid containing cavity, the impeller includes a rotating shaft and blades that can rotate around the rotating shaft, the rotating shaft is provided with a third magnetic block, and the third magnetic block and the first magnetic block are relatively provided on the upper and lower sides of the sealing cover and attract each other, when the transmission bracket drives the rotating disk to rotate by magnetic attraction, the transmission bracket further drives the impeller to rotate by magnetic attraction.

In a possible embodiment, the first magnetic block includes an edge main block disposed in an edge area of the transmission bracket and a central main block disposed in a center area of the transmission bracket.

The edge main block and the second magnetic block are relatively disposed at the upper and lower sides of the edge area of the sealing cover and attract each other, and the central main block and the third magnetic block are relatively disposed at the upper and lower sides of the central area of the sealing cover and attract each other.

In a possible embodiment, the edge main block includes a first main block, a second main block and a third main block, and an angle of 120° is formed between each two of the first main block, the second main block and the third main block.

The edge area of the rotating disk is further provided with a connecting rod, and the connecting rod includes a first rod, a second rod and a third rod.

The mounting position is provided at the central area of the rotating disk, the second magnetic block includes edge follower block at the edge area of the rotating disk, the edge follower block includes a first follower block, a second follower block and a third follower block, the first follower block is fixedly connected to the bottom of the first rod, the second follower block is fixedly connected to the bottom of the second rod, and the third follower block is fixedly connected to the bottom of the third rod.

The first main block and the first follower block are disposed opposite to each other and attract each other, the second main block and the second follower block are disposed opposite to each other and attract each other, and the third main block and the third follower block are disposed opposite to each other and attract each other.

In a possible embodiment, the snow globe ornament further includes a impeller platform disposed below the rotating disk, the impeller platform includes a platform top and a platform column, the top of the platform column is connected to the platform top, the bottom of the platform column is connected to the sealing cover, the platform column forms a cavity between the platform top and the sealing cover, and the impeller is arranged in the cavity.

In a possible embodiment, a positioning rod is provided in the central area of the platform top, a through hole is provided in the central area of the rotating disk, and the positioning rod is inserted into the through hole to enable the impeller platform is connected to the rotating disk.

In a possible embodiment, the connecting rod forms a gap between the platform top and the rotating disk, a protruding structure is provided on the surface of the platform top facing towards the rotating disk, and the protruding structure and the rotating disk are not in contact.

In a possible embodiment, the sealing cover is further provided with a liquid injection hole for injecting liquid into the liquid containing cavity.

In a possible embodiment, the snow globe ornament further includes a sealing plug, and the sealing plug and the liquid injection hole are detachably connected; when the sealing plug is connected to the liquid injection hole, the sealing plug is interference fit with the liquid injection hole.

Compared with the prior art, the beneficial effects of the present invention are as follows: a snow globe ornament, including a snow globe body and a base arranged up and down, the base comprises a driving mechanism and a rotating structure; wherein the driving mechanism includes a sealing cover, a driving motor and a transmission bracket, the sealing cover and the snow globe body are sealed and connected to form a liquid containing cavity for containing liquid, the transmission bracket is provided between the sealing cover and the driving motor and is disposed below the liquid containing cavity, the transmission bracket is connected to the output shaft of the driving motor and the transmission bracket can rotate around the output shaft of it, and the transmission bracket is provided with a first magnetic block; the rotating structure includes a rotating disk, which is provided inside the liquid containing cavity, the rotating disk is provided with a second magnetic block and a mounting position for the ornament, the second magnetic block and the first magnetic block are relatively disposed at the upper and lower sides of the sealing cover and attract each other; When liquid is injected into the liquid containing cavity and the driving motor is started, the driving motor drives the transmission bracket to rotate through the output shaft, then the rotated transmission bracket drives the rotating disk to rotate through magnetic attraction, so as to drive the ornament installed at the installation position to rotate. Compared with the traditional snow globe ornaments in prior art that provide a single dynamic visual expression by small particles, the snow globe ornament provided in this embodiment can perform rotation movement through the rotating structure driven by the driving mechanism, thereby driving the ornament installed on the rotating structure to rotate, creating richer dynamic visual effects, which not only significantly enhances visual appeal, but also effectively meets users'needs for novelty and diversified visual effects, and effectively improves user experience and product market appeal.

### BRIEF DESCRIPTION OF THE DRAWINGS

FIG. 1 is an exploded structural view of a snow globe ornament provided by an embodiment of the present invention.

FIG. 2 is a schematic structural view of a base of the snow globe ornament provided by the embodiment of the present invention.

FIG. 3 is an exploded structural view of the base of the snow globe ornament provided by the embodiment of the present invention.

FIG. 4 is a schematic structural view of a sealing cover of the snow globe ornament provided by the embodiment of the present invention.

FIG. 5 is a schematic structural view of a rotating disk of the snow globe ornament provided by the embodiment of the present invention.

FIG. 6 is a schematic structural view of a impeller platform of the snow globe ornament provided by the embodiment of the present invention.

FIG. 7 is a schematic structural view of an impeller of the snow globe ornament provided by the embodiment of the present invention.

FIG. 8 is a schematic structural view of a transmission bracket of the snow globe ornament provided by the embodiment of the present invention.

### DETAILED DESCRIPTION OF THE PREFERRED EMBODIMENTS

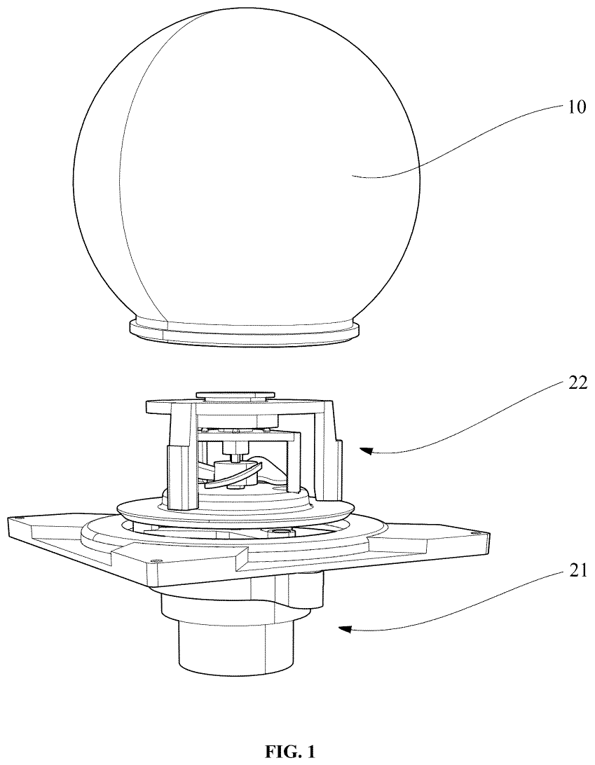

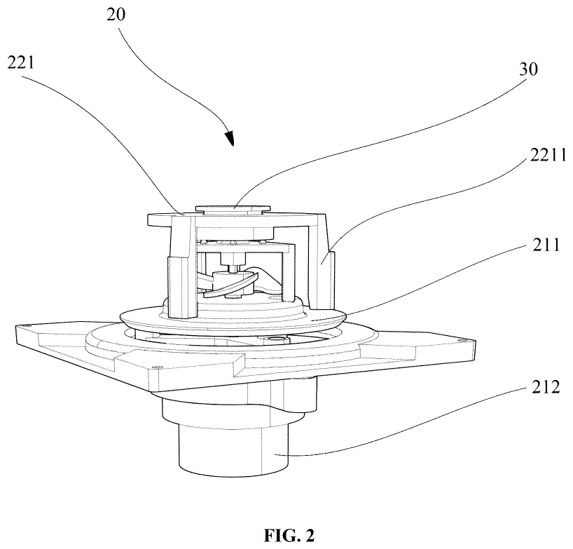

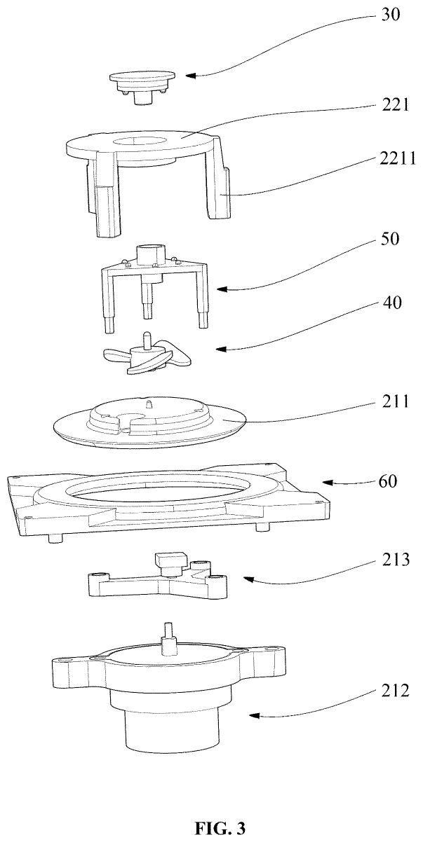

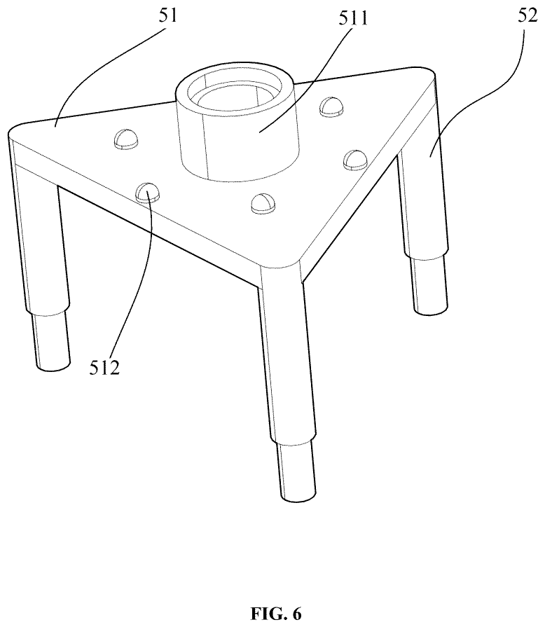

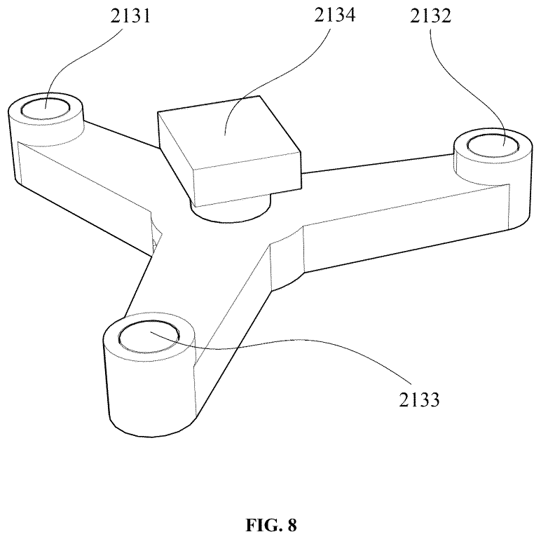

Other features, objects and advantages of the present invention will be more clearly and completely by the detailed description of the non-limiting embodiments with reference to the attached drawings (FIG. 1 to FIG. 8). Obviously, the described embodiments are only part of the embodiments of the present invention, but not all of them. Based on the embodiments of the present invention, all other embodiments obtained by ordinary technicians in the field without creative labor are within the scope of the present invention.

In the present invention, the use of orientation words such as “upper, “lower”, “main”, “edge” are only for the convenience of description, rather than indicating or implying the specific orientation, therefore it should not be construed as being limited to the description of the following embodiments.

In addition, it should be noted that the terms “first”, “second”, “third” and the like in the description and claims of the present invention and the above drawings are used to distinguish similar objects, which are not necessarily used to describe the specific order or sequence. It is to be understood that the data so used are interchangeable under appropriate circumstances in order to describe the embodiments of the invention herein.

Referring to FIGS. 1-8, the present invention provides a snow globe ornament, comprising a snow globe body 10 and a base 20 arranged up and down, and the base 20 comprises a driving mechanism 21 and a rotating structure 22; wherein,
the driving mechanism 21 includes a sealing cover 211, a driving motor 212 and a transmission bracket 213. The sealing cover 211 and the snow globe body 10 are sealed and connected to form a liquid containing cavity for containing liquid, the transmission bracket 213 is provided between the sealing cover 211 and the driving motor 212 and is disposed below the liquid containing cavity, the transmission bracket 213 is connected to the output shaft of the driving motor 212 and the transmission bracket 213 can rotate around the output shaft of it, and the transmission bracket 213 is provided with a first magnetic block.
the rotating structure 22 includes a rotating disk 221, which is provided inside the liquid containing cavity. The rotating disk 221 is provided with a second magnetic block and a mounting position for the ornament 3, the second magnetic block and the first magnetic block are relatively disposed at the upper and lower sides of the sealing cover 211 and attract each other.

When liquid is injected into the liquid containing cavity and the driving motor 212 is started, the driving motor 212 drives the transmission bracket 213 to rotate through the output shaft, then the rotated transmission bracket 213 drives the rotating disk 221 to rotate through magnetic attraction, so as to drive the ornament 30 installed at the installation position to rotate.

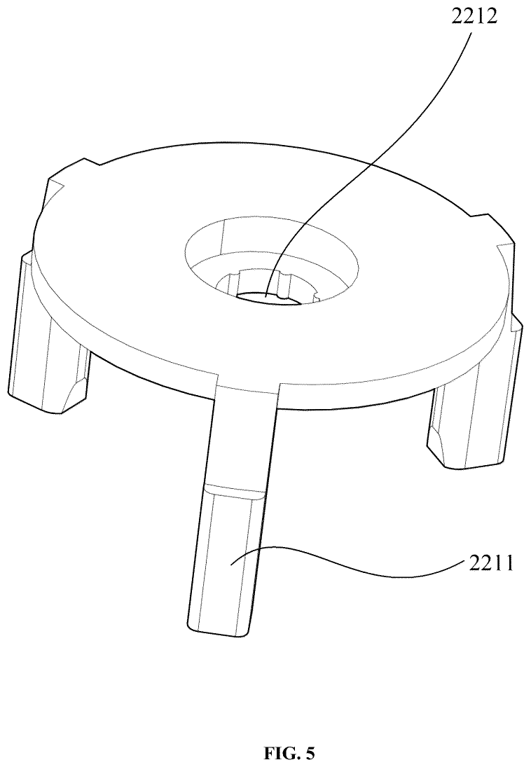

Specifically, the first magnetic block and the second magnetic block are separated by the sealing cover 211 and form a mutually attractive state relative to each other up and down, so that the transmission bracket 213 with the first magnetic block can stably drive the rotation of rotating disk 221 with the second magnetic block to rotate. Specifically, the first magnetic block is fixedly connected to the transmission bracket 213, the second magnetic block is fixedly connected to the rotating disk 221, and the transmission bracket 213 can effectively transfer power to the rotating disk 221 and drive the rotating disk 221 to rotate due to the magnetic attraction. This magnetic connection method can realize power transmission without direct mechanical contact, reduce mechanical wear and extend the service life of the snow globe ornaments. it should be noted that the second magnetic block (the second magnetic block is not shown in FIG. 5) is provided inside the rotating disk 221 and is completely sealed and covered by the rotating disk 221. This design effectively improves the waterproofness of the second magnet block, prevents the second magnet block from contacting the liquid in the liquid-containing cavity, and ensures the long-term stability of its performance. In addition, the first magnetic block is disposed below the liquid containing cavity and isolated by the sealing cover 211, which will not contact the liquid in the liquid containing cavity. Therefore, it can be provided on the top of the transmission bracket 213 to shorten the distance with the second magnetic block as much as possible, thereby enhancing the attraction between the them and ensuring the reliable operation of the first magnetic block and the second magnetic block in a liquid environment.

Specifically, clear water can be injected into the snow globe body 10, which can ensure its transparency and visual effects, and better displaying the interior ornament 30 or landscape. In addition, colored liquid, perfume or luminous liquid can also be chosen to enhance the artistic effect and ornamental value of the snow globe ornaments. In practical application, users can choose a snow globe ornament according to their personal preferences and aesthetic needs.

Compared with the traditional snow globe ornaments in prior art that provide a s ingle dynamic visual expression by small particles, the snow globe ornament provided in this embodiment can perform rotation movement through the rotating structure 22 driven by the driving mechanism 21, thereby creating richer dynamic visual effects, which not only significantly enhances visual appeal, but also effectively meets users' needs for novelty and diversified visual effects, and effectively improves user experience and product market appeal.

In some embodiments of the present application, the snow globe ornament further includes an ornament 30 and dispersed pieces, the ornament 30 is fixedly connected to the aforementioned mounting position, and the dispersed pieces are provided in the liquid containing cavity.

Specifically, the ornament 30 is usually large in size and diverse in shape, which can presents a more complex and vivid design. For example, ornament 30 can be provided in a snowman, a cartoon bear or a sailboat, etc., (only the disc is shown as the ornament 30 in the figure, but in practical application, various ornaments 30 can be chosen and installed in the installation position to enrich the overall effect), which not only have obvious shape features, but also can enhance visual appeal through detailed design such as expressions, clothing, decorations, etc., thereby providing a better user experience and increasing interactivity and fun. In contrast, dispersed pieces (i.e., small granular objects) are usually small in size and simple in shape, which can be provided in small balls, small particles or small pieces of colored paper. The dispersed pieces are often presented in a single visual expression and lack rich details and dynamic expression. Although these dispersed pieces can attract the attention of users, their user experience is relatively limited and mainly depends on their decorativeness due to the lack of diversified designs and dynamic effects. In the snow globe ornament, the combination of ornament 30 and dispersed pieces can provide a better dynamic visual experience and enhance the fun of the product, thereby occupying a more advantageous position in the market.

In some embodiments of the present application, the snow globe ornament further includes an impeller 40 provided inside the liquid containing cavity, the impeller 40 includes a rotating shaft 41 and blades 42 that can rotate around the rotating shaft 41, the rotating shaft 41 is provided with a third magnetic block, and the third magnetic block and the first magnetic block are relatively provided on the upper and lower sides of the sealing cover 211 and attract each other, when the transmission bracket 213 drives the rotating disk 221 to rotate by magnetic attraction, the transmission bracket 213 further drives the impeller 40 to rotate by magnetic attraction.

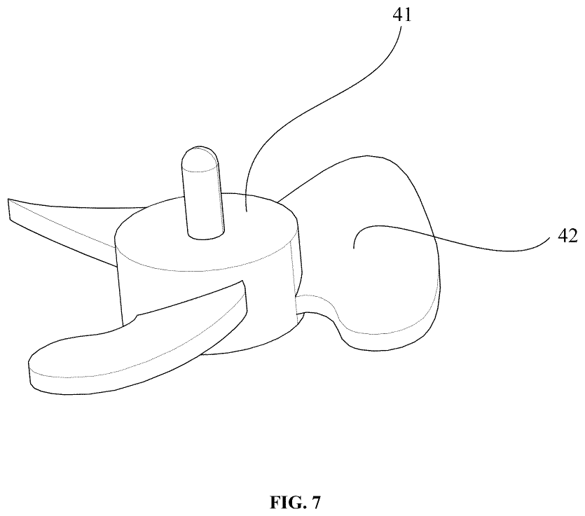

Specifically, the transmission bracket 213 can effectively drive the impeller 40 to rotate, and the impeller 40 has a strong liquid stirring ability. Through the rotation of the impeller 40, it can stirs the nearby liquid to form a flow, breaks the aggregation between the dispersed pieces, and promotes the evenly distribution of dispersed pieces in the liquid within the liquid containing cavity. This process not only improves the overall visual effect of the liquid, but also ensures that the fully decorative function of dispersed pieces. It should be noted that the impeller 40 can be provided in the central area of the sealing cover 211, and the surface of the sealing cover 211 is designed as a slope that gradually slopes downward from the edge area to the center area. The design of this slope can effectively guide most of the dispersed pieces in the liquid containing cavity to be deposited in the central area of the sealing cover 211 in a static state, that is, the lowest position of the entire slope. When the impeller 40 is provided in the central area of the sealing cover 211, the effect of the impeller 40 is maximized, and the dispersed pieces deposited in the central area can be more effectively dispersed and resuspended in the liquid. In addition, in order to improve the waterproofness of the third magnetic block, the third magnetic block (the third magnetic block is not shown in FIG. 7) is provided inside the rotating shaft 41 and is completely sealed and covered by the rotating shaft 41.

In some embodiments of the present application, the first magnetic block includes an edge main block disposed in an edge area of the transmission bracket 213 and a central main block 2134 disposed in a center area of the transmission bracket 213.

Wherein, the edge main block and the second magnetic block are relatively disposed at the upper and lower sides of the edge area of the sealing cover 211 and attract each other, and the central main block 2134 and the third magnetic block are relatively disposed at the upper and lower sides of the central area of the sealing cover 211 and attract each other.

Specifically, the edge main block that attracts the second magnetic block is provided in the edge area of the transmission bracket 213, and correspondingly the second magnetic block is provided in the edge area of the sealing cover 211. The volume and weight of the ornament 30 are usually large, a single power point may not be able to stably and effectively drive its rotation, thus multiple magnetic attraction points are provided in the edge area to enhance the attraction of the ornament 30. Through the structure of multi-point magnetic attraction, the ornament 30 can be affected by the magnetic force from multiple magnetic attraction points in the edge area, achieving more stable rotation or movement, and increasing its dynamic effect. The central main block 2134 that attracts the third magnetic block is arranged in the central area of the transmission bracket 213, and correspondingly the third magnetic block is provided in the central area of the sealing cover 211 to ensure that the impeller 40 rotates effectively. Through the rotation of the impeller 40, the liquid is stirred and forms a flow, thereby breaking the aggregation between the dispersed parts and promoting their evenly distribution in the liquid. The synchronous rotation of the rotating disk 221 and the impeller 40 forms a system in which the ornament 30 and the dispersed pieces move synchronously and dynamically, which significantly improves the function and aesthetics of the snow globe ornament.

In some embodiments of the present application, the edge main block includes a first main block 2131, a second main block 2132 and a third main block 2133, and an angle of 120° is formed between each two of the first main block 2131, the second main block 2132 and the third main block 2133.

The edge area of the rotating disk 221 is further provided with a connecting rod 2211, and the connecting rod 2211 includes a first rod, a second rod and a third rod.

The mounting position is provided at the central area of the rotating disk 221, the second magnetic block includes edge follower block at the edge area of the rotating disk 221, the edge follower block includes a first follower block, a second follower block and a third follower block, the first follower block is fixedly connected to the bottom of the first rod, the second follower block is fixedly connected to the bottom of the second rod, and the third follower block is fixedly connected to the bottom of the third rod.

The first main block 2131 and the first follower block are disposed opposite to each other and attract each other, the second main block 2132 and the second follower block are disposed opposite to each other and attract each other, and the third main block 2133 and the third follower block are disposed opposite to each other and attract each other.

Specifically, by respectively providing three edge main blocks (the first main block 2131, the second main block 2132 and the third main block 2133) and corresponding edge follower blocks (the first follower block, the second follower block and the third follower block) at the edge areas of the transmission bracket 213 and the rotating disk 221, a magnetic attraction system with three magnetic attraction points is formed. A mutual attraction relationship is formed between each edge main block and its corresponding edge follower block, which can significantly enhance the attraction to the ornament 30 installed at the installation position. The multiple points attraction design can ensure that the ornament 30 is more stable during rotation and reduce the deviation or imbalance caused by a single attraction point. In addition, an angle of 120° is formed between the three main blocks, so that the magnetic force is evenly distributed in the edge area, which helps to maintain the balance of the ornament 30 during rotation and avoid rotation instability caused by the magnetic force concentration on one side.

In some embodiments of the present application, the snow globe ornament further includes a impeller platform 50 disposed below the rotating disk 221, the impeller platform 50 includes a platform top 51 and a platform column 52, the top of the platform column 52 is connected to the platform top 51, the bottom of the platform column 52 is connected to the sealing cover 211, the platform column 52 forms a cavity between the platform top 51 and the sealing cover 211, and the impeller 40 is arranged in the cavity.

Specifically, a impeller platform 50 is disposed below the rotating disk 221, and the impeller 40 is provided in the cavity formed between the platform top 51 and the sealing cover 211, so that the rotating disk 221 and the impeller 40 can rotate independently of each other. This independence ensures that the movements of the rotating disk 221 and the impeller 40 do not interfere with each other, ensuring the stability and durability of the rotational movement, reducing the friction and wear caused by direct mechanical contact, and further extending the service life of the snow globe ornament.

In some embodiments of the present application, a positioning rod 511 is provided in the central area of the platform top 51, a through hole 2212 is provided in the central area of the rotating disk 221, and the positioning rod 511 is inserted into the through hole 2212 to enable the impeller platform 50 is connected to the rotating disk 221.

Specifically, the structure of the positioning rod 511 ensures the accurate and precise position between the impeller platform 50 and the rotating disk 221, avoiding deviation or instability caused by improper installation, which is essential to ensure the balance and normal operation of the rotating disk 221. Through the cooperation of the positioning rod 511 and the through hole 2212, the impeller platform 50 and the rotating disk 221 can be stably connected together to form an integral structure. This integration structure not only improves the stability of the product, but also simplifies the assembly process, making the overall design more compact.

In some embodiments of the present application, the connecting rod 2211 forms a gap between the platform top 51 and the rotating disk 221, a protruding structure 512 is provided on the surface of the platform top 51 facing towards the rotating disk 221, and the protruding structure 512 and the rotating disk 221 are not in contact.

Specifically, the structure of the connecting rod 2211 forms a gap between the platform top 51 and the rotating disk 221, the existence of the gap helps to reduce the friction between the platform top 51 and the rotating disk 221, and reduce energy wear. The existence of the protruding structure 512 also effectively reduces the contact area between the platform top 51 and the dispersed pieces deposited on the platform top 51, thereby reducing the possibility of dispersed pieces deposited on the surface of the table 51 due to adsorption (dispersed pieces with light weight and large surface area are easily adsorbed by liquid), effectively improving the fluidity and stirring effect of the dispersed pieces, and avoiding the potential adsorption influence on the dispersing effect and overall liquid performance. The shape and height of the protruding structure 512 can be adjusted according to different types of dispersed pieces to meet different usage requirements. This flexible design of the snow globe ornament can better meet the diverse needs of users.

It should be noted that a mounting base 60 can be fixedly provided on the base 20, the mounting base 60 is provided in square, and screw holes are respectively provided at the four corners of the square, so as to be screwed to the housing (not shown in the figure) for decoration and protection. The screw connection method enables the connection between the mounting base 60 and the housing to be easily disassembled and assembled, which is convenient for maintenance and cleaning, and further enhances the user experience. The base 20 is fixedly connected to the mounting base 60 and provided inside the housing, which can not only effectively covers the complex structure of the base 20, but also provide a certain protection for the base 20, and enhances the overall aesthetics of the snow globe ornament. At the same time, the housing provides the necessary support for the snow globe body 10 to ensure the overall stability. In addition, in order to enhance the customer experience, other functional components can be integrated to the housing to realize additional functions, such as power supply, controller or lighting system. this design not only enhances the practicality of the product, but also brings more convenience and fun to the user.

In some embodiments of the present application, the sealing cover 211 is further provided with a liquid injection hole 2111 for injecting liquid into the liquid containing cavity.

Specifically, the liquid injection hole 2111 is a circular through hole, through which the user can conveniently inject liquid into the liquid containing cavity.

In some embodiments of the present application, the snow globe ornament further includes a sealing plug, and the sealing plug and the liquid injection hole 2111 are detachably connected; when the sealing plug is connected to the liquid injection hole 2111, the sealing plug is interference fit with the liquid injection hole 2111.

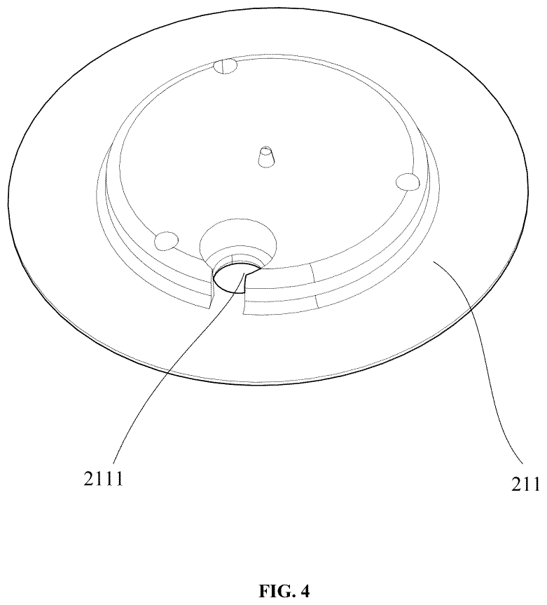

Specifically, the sealing plug (the sealing plug is not shown in FIG. 4) can easily close the liquid injection hole 2111 to prevent liquid leakage or contamination. The sealing plug is usually a rubber plug, the rubber plug is easy to manufacture and install, and the production cost is relatively low, which can effectively reduce the overall cost of the product. The interference fit between the rubber plug and the liquid injection hole 2111 can effectively maintain the liquid in the liquid containing cavity in a sealed state. The detachable design of the sealing plug allows users to easily open and close the liquid injection hole 2111 when replacing the liquids or performing maintenance, thereby improving the flexibility and convenience of use.

The snow globe ornament provided in this embodiment has the characteristics of exquisite design and good dynamic visual effects, further provides a unique home decoration solution for users who pursue personalization and artistic sense.

Hereinafter, embodiments of the present invention have been described in detail with reference to the accompanying drawings. While the description above refers to the particular embodiments of the present invention, it will be understood that many modifications may be made without departing from the spirit thereof. Any equivalent replacement or modification would fall within the protection scope of the present invention.

What is claimed is:

1. A snow globe ornament comprising a snow globe body and a base arranged up and down, wherein the base comprises a driving mechanism and a rotating structure;
wherein the driving mechanism includes a sealing cover, a driving motor and a transmission bracket. The sealing cover and the snow globe body are sealed and connected to form a liquid containing cavity for containing liquid, the transmission bracket is provided between the sealing cover and the driving motor and is disposed below the liquid containing cavity, the transmission bracket is connected to the output shaft of the driving motor and the transmission bracket can rotate around the output shaft of it, and the transmission bracket is provided with a first magnetic block; the rotating structure includes a rotating disk, which is provided inside the liquid containing cavity. The rotating disk is provided with a second magnetic block and a mounting position for the ornament, the second magnetic block and the first magnetic block are relatively disposed at the upper and lower sides of the sealing cover and attract each other; and when liquid is injected into the liquid containing cavity and the driving motor is started, the driving motor drives the transmission bracket to rotate through the output shaft, then the rotated transmission bracket drives the rotating disk to rotate through magnetic attraction, so as to drive the ornament installed at the installation position to rotate.

2. The snow globe ornament according to claim 1, further comprising an ornament and dispersed pieces, the ornament is fixedly connected to the aforementioned mounting position, and the dispersed pieces are provided in the liquid containing cavity.

3. The snow globe ornament according to claim 2, further comprising an impeller provided inside the liquid containing cavity, the impeller includes a rotating shaft and blades that can rotate around the rotating shaft, the rotating shaft is provided with a third magnetic block, and the third magnetic block and the first magnetic block are relatively provided on the upper and lower sides of the sealing cover and attract each other, when the transmission bracket drives the rotating disk to rotate by magnetic attraction, the transmission bracket further drives the impeller to rotate by magnetic attraction.

4. The snow globe ornament according to claim 3, wherein the first magnetic block includes an edge main block disposed in an edge area of the transmission bracket and a central main block disposed in a center area of the transmission bracket; and the edge main block and the second magnetic block are relatively disposed at the upper and lower sides of the edge area of the sealing cover and attract each other, and the central main block and the third magnetic block are relatively disposed at the upper and lower sides of the central area of the sealing cover and attract each other.

5. The snow globe ornament according to claim 4, wherein the edge main block includes a first main block, a second main block and a third main block, and an angle of 120° is formed between each two of the first main block, the second main block and the third main block;
wherein the edge area of the rotating disk is further provided with a connecting rod, and the connecting rod includes a first rod, a second rod and a third rod; the mounting position is provided at the central area of the rotating disk, the second magnetic block includes edge follower block at the edge area of the rotating disk, the edge follower block includes a first follower block, a second follower block and a third follower block, the first follower block is fixedly connected to the bottom of the first rod, the second follower block is fixedly connected to the bottom of the second rod, and the third follower block is fixedly connected to the bottom of the third rod;
wherein the first main block and the first follower block are disposed opposite to each other and attract each other, the second main block and the second follower block are disposed opposite to each other and attract each other, and the third main block and the third follower block are disposed opposite to each other and attract each other.

6. The snow globe ornament according to claim 5, further comprising a impeller platform disposed below the rotating disk, the impeller platform includes a platform top and a platform column, the top of the platform column is connected to the platform top, the bottom of the platform column is connected to the sealing cover, the platform column forms a cavity between the platform top and the sealing cover, and the impeller is arranged in the cavity.

7. The snow globe ornament according to claim 6, wherein a positioning rod is provided in the central area of the platform top, a through hole is provided in the central area of the rotating disk, and the positioning rod is inserted into the through hole to enable the impeller platform is connected to the rotating disk.

8. The snow globe ornament according to claim 6, wherein the connecting rod forms a gap between the platform top and the rotating disk, a protruding structure is provided on the surface of the platform top facing towards the rotating disk, and the protruding structure and the rotating disk are not in contact.

9. The snow globe ornament according to claim 1, wherein the sealing cover is further provided with a liquid injection hole for injecting liquid into the liquid containing cavity.

10. The snow globe ornament according to claim 9, further comprising a sealing plug, and the sealing plug and the liquid injection hole are detachably connected; when the sealing plug is connected to the liquid injection hole, the sealing plug is interference fit with the liquid injection hole.
